(19) United States
(12) Patent Application Publication
(10) Pub. No.: US 2011/0146639 A1
(43) Pub. Date: Jun. 23, 2011

(54) OIL SEPARATOR FOR INTERNAL COMBUSTION ENGINE

(75) Inventors: Herve Martinengo, Chilly (FR); Pascal Guerry, Seppois Le Bas (FR); Antony Nollevaux, Champfromier (FR)

(73) Assignee: MGI COUTIER, Champfromier (FR)

(21) Appl. No.: 12/992,643

(22) PCT Filed: May 5, 2009
(86) PCT No.: PCT/FR2009/050824

§ 371 Date: Mar. 8, 2011

(30) Foreign Application Priority Data
May 14, 2008 (FR) 0802609

(51) Int. Cl. F02B 25/06

(52) U.S. Cl. 123/573

(57) ABSTRACT

The invention relates to an oil separator (1) for an internal combustion engine, for at least partially separating the oil from the gases exiting the crankcase of an internal combustion engine, which separator comprises a casing (10) containing therein: an inlet chamber (2) for the oil-laden gases; an outlet chamber (3) for the cleaned gases; at least one intermediate suction chamber (41, 42, 43); and an oil recovery chamber (5) with an opening (50) for returning the separated oil to the engine. The communication interface (53) between the oil recovery chamber (5) and the gas outlet chamber (3) is sized (Ll) in such a way that the pressures in each of the chambers (3, 5) are substantially equal during the use of the separator regardless of the gas flow rate inside said separator (1). The invention can be used in the field of motor vehicles.

### TECHNICAL FIELD

The present invention concerns an oil separator for an internal combustion engine, provided to at least partially separate the oil from the gases exiting the crankcase of an internal combustion engine.

It more particularly concerns a separator comprising a casing containing therein:

an inlet chamber for the oil-laden gases;

an outlet chamber for the cleaned gases;

at least one intermediate suction chamber situated between the inlet chamber and the outlet chamber of the gases and delimited by oil capture means positioned on the circulation path between the inlet chamber and the outlet chamber of the gases, and

an oil recovery chamber with an opening for returning the separated oil to the engine, said opening being situated in the lower portion of the separator, said oil recovery chamber being adjacent to the intermediate suction chamber(s), said or each intermediate suction chamber being in communication with said oil recovery chamber via communication means, and said recovery chamber being in communication on one hand with the gas intake chamber via communication means, and on the other hand with the outlet chamber via a communication interface between the two said chambers.

### BACKGROUND

FIGS. 1 and 2 diagrammatically illustrate the problem at the base of the present invention, i.e. the loading of the oil-laden crankcase gases inside an internal combustion engine, for example of the gasoline or diesel engine type, intended in particular to equip a motor vehicle.

FIG. 1 diagrammatically illustrates, in vertical cross-section, a portion of an internal combustion engine M traditionally comprising a crankcase 900 containing a crankshaft 901 that cooperates, via connecting rods 902, with pistons 903 slidingly mounted in cylinders 904. The crankshaft 901 is lubricated by a lubricating oil H extended in a layer in the crankcase 900. Anti-sparging plates 905 can also be provided in the crankcase 900.

A camshaft 910, mounted inside a cylinder head 911, is also provided to actuate valves, not shown, one or several shafts 912 connecting the crankcase 900 and the cylinder head 911. As illustrated in FIG. 2, nozzles 913 can be provided inside the cylinder head 911 to project lubricating oil H on the camshaft 910, in particular on the bearings 914 of said camshaft 910.

The circulating flows of the crankcase gases are illustrated in FIGS. 1 and 2 by the arrows visible inside the crankcase 900, the shaft 912 and the cylinder head 911. When the engine M is in operation, combustion and compression gases of each cylinder 904 pass from the cylinder towards the crankcase 900, the segments of the pistons 903 not completely stopping the gases. These gases are primarily formed by a mixture of air, fuel, a bit of exhaust gas, steam and lubricating oil. They are evacuated from the crankcase 900, to be reintroduced into the combustion chambers delimited by the cylinders 904.

In one known embodiment, to evacuate the gases from the crankcase 900 and reinject them into an intake line 930, the crankcase 900 is connected to the cylinder head by the shafts 912 passed through by said gases, then the gases are admitted into an oil separator 920, also called compressed air filter, provided to separate the oil from the gases exiting the crankshaft 900 via the cylinder head 911. At the outlet of the separator 920, the cleaned gases rejoin the intake line 930, first passing through a check valve 931 and through a butterfly valve 932; the check valve 931 closing in particular when the vacuum downstream of the butterfly valve 932 is significant. Thus, the gases can be sent back into the cylinder head 910, therefore into the cylinders 904 after separation of the oil from the gases in the separator 920.

The separator 920 is an essential element of the internal combustion engine M that is inserted on the circulation path of the crankcase gases in order to separate the gases from the lubricating oil to be able to reinject the gases into the intake line 930.

Indeed, the crankcase gases are likely to become laden with oil H at different points on their path, in particular:

the cylinders 904 where the movement of the pistons 903 tears, from the inner walls of the cylinders, oil, which loads the gases;

the connecting rods 902 that come into contact with the oil layer, thereby forming suspended oil droplets;

the crankshaft 901, which projects oil into the gas flows;

the oil layer in the bottom of the crankcase 900 where the gases, under the effect of their flow velocity, tear off oil particles that charge them;

the bearings 914 or the shafts 912 whereof the upper portions represent areas of accumulation of oil particles likely to be torn and mixed with the casing gases, despite flared or rounded shapes designed to facilitate the descent of the oil.

When oil H has accumulated on any support in a circulation area of the crankcase gases, under the effect of the velocity of the gases, the accumulated oil come off of its support and can thus arrive in large quantities at the inlet of the separator 920, in the form of large drops or jets or waves of oil.

Thus, the oil arriving in the separator can primarily assume one of the two following phases:

the liquid oil phases corresponding to oil inlets in the form of successive waves, large drops or jets of oil; and

aerosol oil phases, corresponding to oil inlets in small quantities, in particular in the form of small drops suspended in the gases.

It is known, in particular from French patent applications FR 2 898 386 and FR 2 874 646, to provide separators that are particularly well adapted to remove the oil drops suspended in the crankcase gases. Two embodiments of these separators of the prior art are diagrammatically illustrated in horizontal cross-section in FIGS. 3 and 4.

These known separators comprise a casing 810, in elongated form, that contains therein:

an intake chamber 820 for oil-laden casing gases,

an outlet chamber 830 for the cleaned gases,

three intermediate suction chambers 851, 852, 853 situated between the inlet chamber 820 and the outlet chamber 830 of the gases and delimited by obstacle separators 861, 862, 863 positioned on the circulation path between the gas inlet chamber 820 and the gas outlet chamber 830, and

an oil recovery chamber comprising several compartments, namely:
a main compartment 840 in which a return opening 841 is provided for the separated oil towards the engine, said return opening 841 being situated in the lower portion of the separator and forming the inlet of a siphon 842,
one or two intermediate compartments 843, 844 between the gas inlet chamber 820 and the main compartment 840,
said compartments 840, 843, 844 being adjacent to the intermediate suction chambers 851, 852, 853 with which they are in communication via communication openings 871, 872, 873, respectively, for the passage of the oil that flows mainly towards the return opening 841, then towards the siphon 842.

Just upstream of the outlet chamber 830 is a venturi 880 that communicates with the main oil recovery compartment 840 via a vacuum opening 881 of said main compartment 840; said vacuum opening 881 being situated in the upper portion of the separator. The intermediate suction chamber 853 situated directly upstream of the outlet chamber 830 thus extends via the venturi 880 and communicates with the main compartment 840 via the communication opening 873 for the passage of the oil that flows primarily through gravity in the separator.

The inlet chamber 820 is in communication with the first intermediate compartment 843 via a communication opening 845.

In the embodiment of FIG. 3 where two intermediate compartments 843, 844 are provided, the first intermediate compartment 843 is in communication with the adjacent second intermediate compartment 844 via a communication opening 846, and the second intermediate compartment 844 is in communication with the adjacent main compartment 840 via a communication opening 847.

In the embodiment of FIG. 4 where a single intermediate compartment 843 is provided, said intermediate compartment 843 is in communication with the adjacent main compartment 840 via the communication opening 846.

The siphon 842 ensures the presence of a sufficient oil reserve at the bottom of the separator, i.e. in the lower portion of the main compartment 840 of the oil recovery chamber, which prevents the entry of non-cleaned gas via the oil return opening 841, offsetting the pressure drop ΔP=P1−P2 respectively between the inlet chamber 820 at pressure P1, corresponding to the pressure in the cylinder head at the inlet of the separator, and the main compartment 840 at pressure P2 above the siphon 842.

The siphon 842 serves to move the oil from the main compartment 840 to an outer area of the separator in communication with the engine, in particular inside the cylinder head above which said separator is positioned; the main compartment 840 being in vacuum in relation to said outer area. The pressure difference ΔP=P1−P2 between the cylinder head and the main compartment 840 determines the oil height HH in the siphon 842, corresponding to the level difference between the two free surfaces of the oil H at pressure P1, corresponding to the outer pressure and also to the inlet pressure of the separator, and to the pressure P2 where P2 is less than P1, respectively.

Thus, this pressure difference ΔP is determined in particular by the height Hs of the siphon 842, where the larger this height Hs, the greater the pressure difference ΔP can be. This pressure difference ΔP is related to the velocities of the gases in the separator: the higher the velocity, the more significant the pressure drop ΔP and the more the height Hs of the siphon 842 must be large to cause the oil H to return towards the engine.

This type of separator is intended to continuously remove all or part of the oil present in the casing gases. In the case where the separator is dimensioned not to treat small oil drops, i.e. to separate the oil from the gases only starting from a predetermined size of the oil particles present in the gas, it has nevertheless been noted that this type of separator no longer works when a wave of oil or several successive waves of oil arrive at the inlet of the separator; a wave of oil corresponding to a significant flood of oil admitted in the separator in particular following the unsticking of the oil previously accumulated in accumulation areas as described above.

Moreover, on the current engines, the tendency is to reduce the dimensions of the engine while increasing the power thereof. The increase in the power results in increasing the casing gas flow rates, while the reduction of the dimensions results in decreasing the available space for the separator. One of the problems of the separators is therefore to be able to treat more casing gases, in other words larger gas flow rates, in a smaller volume.

The reduction of the available space has repercussions on all of the elements of the engine, and in particular on the space available for the distribution. Thus, the camshaft and cams are increasingly close to the inlet of the separator and the casing gas velocities increase, due in particular to the reduction of the passage sections of the gases and the increased flow rate. Moreover, the quantities of oil lubricating these elements are increased.

As a result of all of this, the projections of oil in the form of large drops, jets or waves at the inlet of the separator are increasingly significant.

The Applicant noticed that the majority of the oil arriving at the inlet of the separator arrives in the form of large drops, jets and waves, whereas there is a smaller quantity of oil in the form of small drops. To provide an order of magnitude, considering a worn engine operating at full power, the flow rate of oil in small drop form arriving at the inlet of the separator is in the vicinity of 4 g/h, while the flow rate of oil arriving in the form of large drops, jets or waves is in the vicinity of 1200 g/h.

In a first case, when a large quantity of oil is non-continuously admitted into the separator, such as for example in the form of successive waves of oil H illustrated in FIG. 6, the oil H tends to plug the communicating openings, openings 845 and 871 successively. The entering wave of oil is in fact separated a first time by the first obstacle separator 861 and the opening 871 will evacuate the biggest part of that wave, momentarily plugging at the oil passage. Moreover, when the oil passes through the opening 845, the oil will momentarily plug said opening 845 such that, and also due to the fact that the velocity of the gases in the venturi 880 is increasing, the pressure P2 decreases in the main compartment 840. The same phenomenon also occurs at the oil passage in the following openings, i.e. openings 846 and 872, then in the last opening 873 with lesser effects because the quantity of oil decreases after each obstacle separator row 862, 863. Such waves of oil H have the result that the pressure P2 decreases in the main compartment 840, therefore the pressure drop ΔP increases, such that the oil height HH increases and the oil level H increases in the main compartment 840.

When there are frequent oil waves H at the inlet, the siphon 842 no longer has an emptying period. The main compartment 840 fills completely and the oil H ends up passing through the vacuum opening 881 between the main compartment 840 and the venturi 880. Moreover, the successive passage of large quantities of oil H in the successive openings 845, 846, 871, 872, 873 creates pressure instabilities in the main compartment 840, and thus instabilities of the siphon 842 may begin. Indeed, when the pressure P2 is low enough, the siphon 842 can be drained, i.e. gas, in the form of bubbles B illustrated in FIG. 7, passes through the siphon 842. The draining or planing of the siphon 842 will therefore produce gas bubbles B that will burst at the free oil surface H in the main compartment 840, creating oil droplets able to be driven by the gases circulating in the main compartment 840 in the intake line.

To avoid this phenomenon of emptying of the siphon 842 when successive waves of oil enter the separator, it would therefore be necessary, following a simplistic approach, for the openings, in particular the openings furthest upstream 845 and 871, to be as large as possible to avoid being obstructed by the oil.

In a second case, when a small quantity of oil arrives at the separator's inlet, the flow of the gases is then not very disrupted by the presence or absence of the oil at the various openings 845, 846, 871, 872, 873.

Assuming that the opening 845 is very large, as suggested by the approach above and as illustrated in FIG. 8 (in the absence here of intermediate compartment), this opening 845 will create very little pressure drop such that the pressure P1 at the inlet of the separator will be equal to the pressure P2 in the main compartment 840 forming the oil recovery chamber. The respective pressures P11, P12 and P13 in the intermediate suction chambers 851, 852 and 853, respectively, and the pressure P8 in the venturi 880 will all be lower than the pressure P1. Thus, the gas circulating flows in the openings 871, 872 and 873 will be oriented in the wrong direction, i.e. from the oil recovery chamber 840 towards the intermediate suction chambers, and no oil will be suctioned via these openings 871, 872, 873.

Likewise, assuming that the opening 871 is very large, as illustrated in FIG. 9 (in the absence here also of intermediate compartment), this opening 871 will create very little pressure drop such that the pressure P11 in the first intermediate suction chamber 851 will be equal to the pressure P2 in the main compartment 840 forming the oil recovery chamber. The pressures P12 and P13 in the following intermediate suction chambers, 852 and 853, respectively, and the pressure P8 in the venturi 880 will all be lower than the pressure P1. Thus, the gas circulating flows in the openings 872 and 873 will be oriented in the wrong direction, i.e. from the oil recovery chamber 840 towards the corresponding intermediate suction chambers 852 and 853, and no oil will be suctioned via these openings 872, 873.

Thus, for all of the openings 871, 872, 873 for communication between the intermediate suction chambers 851, 852, 853 and the oil recovery chamber 840 suctioning the oil, it is necessary not to enlarge the communication openings 845, 846, 871, 872, 873 too much. Ideally, the opening 845 must be smaller than the opening 871, itself smaller than the opening 872, etc., so that these openings have the same suction flow rate. Nevertheless, this problem is particularly difficult to resolve on the last communication opening 873, especially when the height of the siphon 842 is small because it is limited for bulk reasons.

Thus, this teaching goes against the preceding teaching that indicates that to treat waves of oil at the inlet of the separator, it is necessary to have communication openings with large dimensions.

This type of separator thus has the drawback of not being able to treat both cases in a satisfactory manner, i.e.:

the liquid oil phases corresponding to oil inlets in the form of successive waves, large drops or jets of oil; and

aerosol oil phases, corresponding to oil inlets in small quantities, in particular in the form of small drops suspended in the gases.

Moreover, it should be noted that the narrowing of the gas circulation area forming the venturi is a difficult and costly zone to produce by molding in a plastic material, and also offers an area in the separator that is not as robust, for example with regard to impacts on the separator.

### BRIEF SUMMARY

The present invention aims in particular to eliminate all or part of the aforementioned drawbacks, in particular by enabling the efficient treatment of oil in liquid phase, and to that end proposes an oil separator for an internal combustion engine, for at least partially separating the oil from the gases exiting the crankcase of an internal combustion engine, the separator comprising a casing containing therein:

an inlet chamber for the oil-laden gases;

an outlet chamber for the cleaned gases;

at least one intermediate suction chamber situated between the inlet chamber and the outlet chamber of the gases and delimited by oil capture means positioned on the circulation path between the inlet chamber and the outlet chamber of the gases, and

an oil recovery chamber with an opening for returning the separated oil to the engine, said opening being situated in the lower portion of the separator, said oil recovery chamber being adjacent to the intermediate suction chamber(s), said or each intermediate suction chamber being in communication with said oil recovery chamber via communication means, and said recovery chamber being in communication on one hand with the gas intake chamber via communication means, and on the other hand with the outlet chamber via a communication interface between the two said chambers,

the separator being remarkable in that the communication interface between the oil recovery chamber and the gas outlet chamber is dimensioned so that the pressures in each of said chambers are substantially equal during use of the separator independently of the circulating flow rate of the gases inside said separator.

The invention therefore proposes to eliminate the narrowing of the gas circulating area forming the venturi and to establish a pressure balance between the outlet chamber and the oil recovery chamber.

Thus, the pressures in the outlet chamber and the oil recovery chamber are equal, such that if waves of oil plug the communication openings, the pressure in the oil recovery chamber, just above the oil return opening, does not change. The pressure in the oil recovery chamber is thus independent of the arrival or absence of waves of oil, preventing successive waves of oil from creating pressure instabilities in the separator and operating instabilities, such as emptying of the siphon.

According to one feature, the communication interface between the oil recovery chamber and the gas outlet chamber assumes the form of a vertical drop, in particular of the step type, associated with a level difference between the respective bottoms of said chambers in order to prevent the oil accumulating in the oil recovery chamber from passing into the gas outlet chamber via said communication interface.

In one particular embodiment, the separator comprises several successive intermediate suction chambers separated from each other by oil capture means.

In one particular embodiment, the oil recovery chamber includes several successive compartments, in communication via communication means, including:

a main compartment in which the separated oil return opening is provided, and

at least one intermediate compartment situated between the gas intake chamber and the main compartment,

each compartment being adjacent to at least one suction chamber with which it is in communication via communication means.

According to one feature, the sole intermediate suction chamber or the intermediate suction chamber directly upstream of the outlet chamber is in communication with said outlet chamber via a convergence area intended to concentrate the gas circulation flow in the upper portion of the separator, opposite the lower portion of the separator in which the separated oil return opening is situated.

Thus, the flow of gas passing through the intermediate suction chamber(s), called main gas flow, does not disrupt the oil recovery chamber or its main compartment, and more particularly the separated oil return opening. Thus, the main gas flow does not disrupt the pressure in the oil recovery chamber or in the main compartment.

Advantageously, the convergence area assumes the form of a wall inclined on the horizontal, oriented towards the upper portion of the separator in the circulation direction of the gas flow.

This inclined wall preferably forms a connecting wall between the bottom of the outlet chamber and the bottom of said intermediate suction chamber when said bottoms are not situated at the same level.

According to another feature, all or part of the communication means comprise at least one opening provided between the two corresponding communicating compartments or chambers.

It is understood that these communication means concern the communication between the oil recovery chamber, or its compartments, and the intermediate suction chamber(s), between the compartments of the oil recovery chamber, between the oil recovery chamber and the gas inlet chamber.

In one advantageous embodiment, all or part of the communication means comprise at least two openings provided between the two corresponding communicating compartments or chambers, said openings being situated at distinct levels so that an opening situated in the lower portion of the separator is dedicated primarily to the passage of the oil and an opening situated in the upper portion of the separator is dedicated primarily to the passage of the gases.

Thus, the oil recovered by the capture means flowing primarily by gravity will tend to pass in the oil recovery chamber, or in one of its compartments, via the opening situated in the lower portion; whereas the gases will tend to pass into the oil recovery chamber, or into one of its compartments, via the opening situated in the upper portion. In particular, the waves of oil or the large successive drops, i.e. the oil in liquid phase and not in aerosol phase, flow primarily in the lower portion of the separator, corresponding to the floor of the separator, and therefore pass primarily through the opening(s) in the lower portion, thereby limiting the risk of blocking the gas flow opening situated in the upper portion, and creating operating instabilities of the separator.

It is understood that top and bottom are used in reference to the vertical direction associated with the gravitational force and the usage position of the separator mounted in the motor vehicle. Indeed, it is recalled here that the separation is a mechanical separation operation, under the main action of gravity, of several non-miscible phases.

Of course, such a design of the communication means, in the form of openings in the upper and lower portion, could be the subject of protection strict sensu.

Advantageously, the two openings correspond to free spaces between a separating wall of the two corresponding compartments or chambers and the casing of the separator, said separating wall being mounted with play inside said casing, in particular through an assembly by clipping.

Thus, the walls delimiting the chambers and/or the compartments of the oil recovery chamber can have a height smaller than the height of the separator casing, such that said walls are mounted with plays, lower and upper, respectively, at the lower and upper portions, respectively, of the separator casing, such that these plays form passage openings for the oil and for the gasses in the lower and upper portions of the separator, respectively.

In one particular embodiment of the communication means, said or each opening is oblong, in particular rectangular, or square.

In another particular embodiment of the communication means, said or each opening assumes the form of a plurality of holes, in particular polygonal holes, preferably rectangular or square, or circular.

As mentioned above, when a small quantity of oil enters the separator, in particular in aerosol phase, the first communication openings towards the oil recovery chamber have an interest in being small to create the pressure drop, so that the following openings can suction the oil towards the oil recovery chamber. However, the communication openings must allow the oil to pass as easily as possible, and therefore be large. This leads to a contradiction as mentioned above.

The Applicant has, however, noted that the flow of gases through the communication openings is of the turbulent type (the Reynolds number for this fluid being in the vicinity of 6000), whereas the flow of the oil through these same openings is of the laminar type (very low flow velocity, high viscosity and high density of this fluid). For a turbulent flow the shape of the opening has a large impact on the pressure drop, whereas for a laminar flow the shape of the opening has very little impact, only the section of the passage being important.

Thus, an advantageous shape of the communicating openings is a shape that maximizes the pressure drop of a turbulent flow, corresponding to the flow of the gases. Indeed, for a same passage section or surface, corresponding to a same capacity to evacuate the oil in laminar flow, the shape that maximizes the pressure drop in turbulent flow is that which makes it possible to best stop the gases.

Yet the circular shape of an opening corresponds to the shape that minimizes the pressure drop, whereas there are many other shapes that maximize it and in particular shapes with a significant hydraulic diameter Dh, where:

$${D}_{h} = 4 \frac{S}{P}$$

with

S=passage surface or area of the opening, and

P=perimeter of the passage section of the opening.

For example, for a same hydraulic diameter Dh, an oblong opening, in particular in an elongated rectangular shape, has a greater passage surface than an opening with a circular shape.

The circular opening with a given hydraulic diameter Dh has a diameter D=Dh and a corresponding passage surface Sc.

The rectangular or square opening with the same hydraulic diameter Dh has a passage surface Sr greater than the passage surface Sc of the circular opening.

The opening with the same hydraulic diameter Dh and made up of five square holes also has a passage surface Sm that is greater than the passage surface Sc of the circular opening.

Of course, such a design of the shape of the communication openings could be the subject of protection strict sensu.

In one preferred embodiment of the invention, all or part of the oil capture means comprise an obstacle separator, said obstacle separator comprising at least one passage opening of the gases associated with bypass means positioned opposite said passage opening in order to deviate all or part of the gases passing through said passage opening.

Thus, to facilitate the evacuation of the oil in liquid phase, for example in the form of waves or large drops or jets of oil, it may be advantageous for all or part of the separators to become only a part of the main flow of gas, in order to have separators that create little pressure drop while remaining efficient in the separation of the oil in liquid phase. By decreasing the pressure drop in the intermediate suction chambers, it is for example possible to decrease the dimensions of the siphon, in order to meet bulk restrictions.

In this way, the separator operates primarily to treat oil in liquid phase, with low gas flow velocities and pressure drops to be able to evacuate the oil continuously through the siphon.

Such a separator thus makes it possible to treat the largest quantity of oil arriving at the inlet because, as above, the majority of the oil arrives in the form of large drops, jets and waves; the oil arriving in the form of small drops, in aerosol phase, arrives in small quantities.

According to another feature, when the separator has several successive intermediate suction chambers, the successive oil capture means provided between the successive intermediate suction chambers each comprise an obstacle separator, two successive obstacle separators, respectively, a first separator and a second separator placed downstream of the first separator, being designed so that the first separator deviates less gas flow than the second separator.

Thus, the first separator creates less of a pressure drop than the second separator.

According to another feature, the oil capture means provided between the gas inlet chamber and the intermediate suction chamber situated directly downstream comprise at least one passage opening for the gases. Advantageously, no gas bypass means is provided upstream of said passage opening.

The invention also concerns an oil separating device for an internal combustion engine, for at least partially separating the oil from the gases exiting the crankcase of an internal combustion engine, comprising a separator as described above and a cyclone separator placed behind downstream of said separator to recover all or part of the oil remaining in the gases exiting said separator.

Thus, the separator is intended mainly to treat oil inlets in liquid phase, constituting the majority of the oil inlets in the devices, while being particularly compact, robust and inexpensive. The function of this separator is therefore no longer to have an outlet gas completely rid of oil, but to have a gas where only a small quantity of oil remains in the form of small suspended particles then treated by the cyclone separator placed at the outlet of said separator.

By separating the treating of the oil, with one separator that mainly treats the oil in liquid phase and a cyclone separator that main treats the oil in aerosol phase, it is possible to provide a separator device not having any instability problems, in particular at the siphon of the separator, and that has small dimensions, in particular reducing the pressure drops, and allowing a continuous evacuation of the oil outside the separator, during the operation of the internal combustion engine.

The cyclone separator, which requires a much greater pressure drop to treat the oil in aerosol phase, can on the other hand store the treated oil during the operating time of the combustion engine, before the oil is evacuated in the engine when the engine is stopped, for example via a suitable check valve. The cyclone separator only treating a small amount of oil can therefore have dimensions adapted to the bulk inherent to the engine block.

According to one feature, the cyclone separator comprises a tangential gas inlet containing oil to be recovered, said tangential inlet communicating directly with the gas outlet chamber of the separator.

### BRIEF DESCRIPTION OF THE DRAWINGS

Other features and advantages of the present invention will appear upon reading the detailed description that follows, of several embodiments, done in reference to the appended figures in which:

FIG. 1 is a diagrammatic vertical cross-sectional view of an internal combustion engine portion that can be equipped with a separator or a separating device according to the invention;

FIG. 2 is a detailed diagrammatic vertical cross-section of the cylinder head of the internal combustion engine illustrated in FIG. 1 at the inlet of the separator;

FIGS. 3 and 4 are diagrammatic horizontal cross-sections of two separators of the prior art;

FIG. 5 is a vertical cross-sectional view of the separator illustrated in FIG. 4 along line V-V;

FIG. 6 is a view identical to that of FIG. 4 where waves of oil are illustrated inside the separator;

FIG. 7 is a vertical cross-sectional view of the separator illustrated in FIG. 6 along line VII-VII in a situation of instability due to the waves of oil;

FIGS. 8 and 9 are diagrammatic horizontal cross-sections of two alternatives of the separator illustrated in FIG. 4 illustrating the problem of dimensioning the openings to treat the waves of oil;

FIG. 10 is a diagrammatic horizontal cross-section of a first embodiment of a separator according to the invention;

FIG. 11 is a vertical cross-section of the separator illustrated in FIG. 10 along line XI-XI;

FIG. 12 is a diagrammatic horizontal cross-section of a second embodiment of a separator according to the invention;

FIG. 13 is a vertical cross-sectional view of the separator illustrated in FIG. 12 along line XIII-XIII;

FIG. 14 is a diagrammatic horizontal cross-section of an obstacle separator adapted to equip a separator according to the invention;

FIGS. 15a, 15b and 15c diagrammatically illustrate three types of communication opening between chambers or compartments provided in a separator according to the invention;

FIG. 16 is a view identical to that of FIG. 12 where a wave of oil is illustrated inside the separator;

FIGS. 17a and 17b are vertical cross-sectional views of two alternatives of the separator illustrated in FIG. 16 along line XVII-XVII;

FIGS. 18 to 20 are diagrammatic horizontal cross-sections of three other embodiments of a separator according to the invention;

FIG. 21 is a diagrammatic horizontal cross-section of a separating device according to the invention comprising a separator in series with a cyclone separator;

FIG. 22 is a vertical cross-sectional view of the cyclone separator illustrated in FIG. 21 along line XXII-XXII.

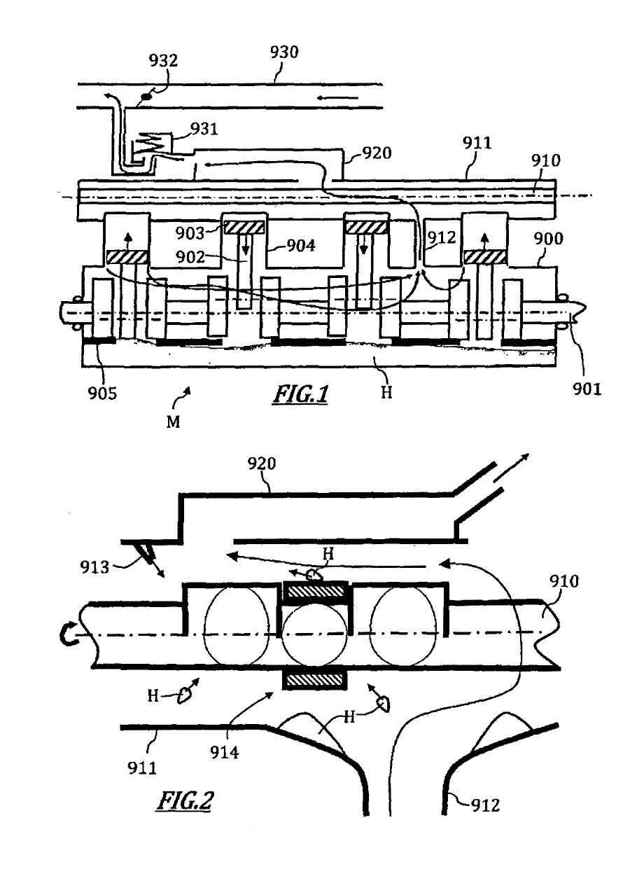

### DETAILED DESCRIPTION

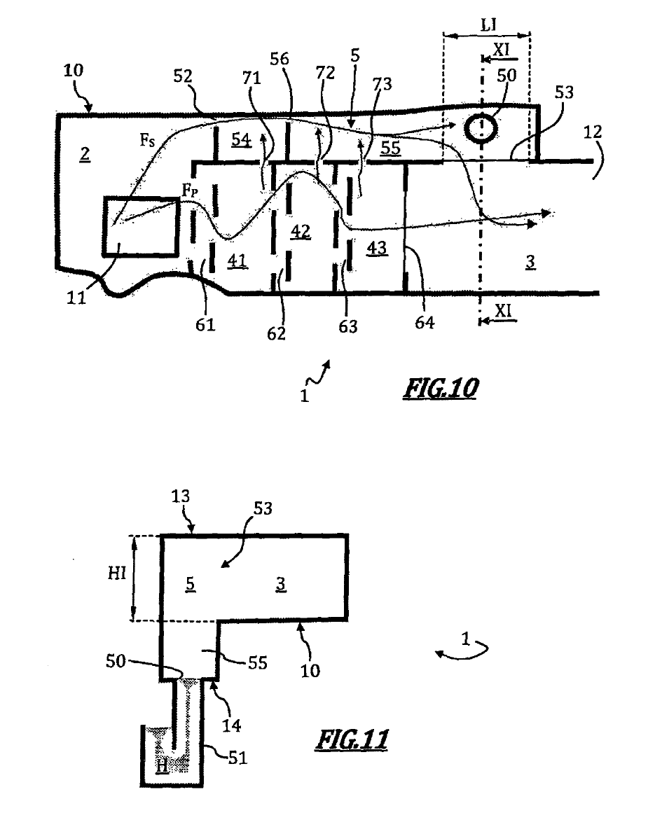

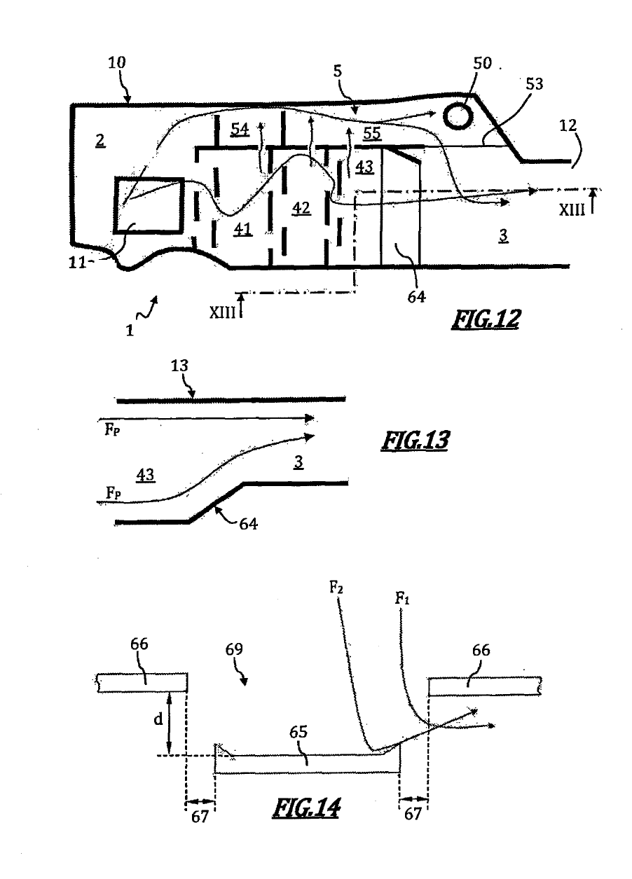

A first embodiment of a separator 1 according to the invention is illustrated in FIG. 10, the other embodiments of the separator 1 illustrated in particular in FIGS. 12, 18, 19 and 20 constituting evolutions of the separator 1 illustrated in FIG. 10.

The separator 1 comprises a casing 10 with an elongated shape, forming a shell or enclosure delimiting an inner space, which is provided at one end with an inlet 11 for the oil-laden gases and at the opposite end with an outlet 12 for the cleaned gases.

The casing 10 of the separator 1 contains therein:

an inlet chamber 2 for the oil-laden gases, the inlet 11 emerging directly in said inlet chamber 2;

an outlet chamber 3 for the cleaned gases in which the outlet 12 is provided;

three intermediate suction chambers 41, 42, 43 situated between the inlet chamber 2 and the outlet chamber 3 of the gases and delimited by oil capture means 61, 62, 63, 64 (described in detail later) positioned on the circulation path between the inlet chamber 2 and the outlet chamber 3 of the gases, and

an oil recovery chamber 5 with an opening for returning the separated oil 50 to the engine, said opening 50 being situated in the lower portion 14 of the separator 1 and forming the inlet of a siphon 51, visible in FIG. 11.

The oil recovery chamber 5 is adjacent to the three intermediate suction chambers 41, 42, 43, each of said intermediate suction chambers 41, 42, 43 being in communication with said oil recovery chamber 5 via communication means, 71, 72, 73, respectively (described in detail later).

Moreover, the recovery chamber 5 is in communication on one hand with the gas inlet chamber 2 via communication means 52 (described in detail later), and on the other hand with the outlet chamber 3 via a communication interface 53 (described in detail later) between said two chambers 3 and 5.

The oil recovery chamber 5 is divided into two successive compartments 54, 55, in communication with each other via communication means 56 (described in detail later):
a first so-called intermediate compartment 54 in communication with the gas intake chamber 2 via the communication means 52,
a second so-called main compartment 55 in which the separated oil return opening 50 is provided, and which is in communication with the gas outlet chamber 3 via the communication interface 53.

The intermediate suction chamber 41 communicates with the intermediate compartment 54 via the communication means 71, while the second 42 and third 43 intermediate suction chambers, respectively, communicate with the main compartment 55 via the communication means 72 and 73, respectively.

Moreover, the first intermediate suction chamber 41 is separated on one hand from the inlet chamber 2 by the first oil capture means 61, and on the other hand from the following second intermediate suction chamber 42 by the second oil capture means 62. Then, said second intermediate suction chamber 42 is separated from the following third intermediate suction chamber 43 by the third oil capture means 63. Lastly, said third intermediate suction chamber 43 is separated from the outlet chamber 3 by the fourth oil capture means 64.

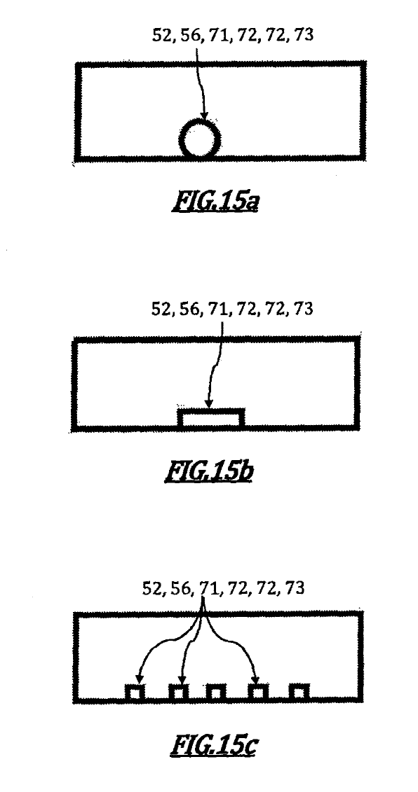

The first 61, second 62 and third successive capture means are each formed by a row of obstacle separators; one embodiment of an obstacle separator being illustrated in detail in FIG. 14. An obstacle separator comprises at least one passage opening 69 for the gases connected with bypass means 65 positioned opposite said passage opening 69 in order to deviate all or part of the gases passing through said passage opening 69. The passage opening 69 can be delimited by two coplanar walls 66 spaced away from each other, and the bypass means 65 are formed by a bypass plate opposite the passage opening 69, parallel to the walls 66, offset in relation to said walls 66 by a distance d, and at least partially covering the passage opening 69 to deviate at least part of the gas flow passing through said passage opening 69; the bypass plate 65 thus being able to allow an interval 67 to remain, on either side of said bypass plate 65, corresponding to a portion of the passage opening 69 not covered by the bypass plate 65. It is possible to provide, on the edge of the bypass plate 65, an adapted geometry, such as for example in the form of an inclined face, to favor the bypass effect. It is thus noted that the gas flow illustrated by arrow F1 arriving in the interval 67 is deviated by the gas flow illustrated by arrow F2 deviated directly by the bypass plate 65.

Returning to FIG. 10, the oil-laden gas flow entering the separator 1 is broken down in particular into two flows between the inlet 11 (or the inlet chamber 2) and the outlet 12 (or the outlet chamber 3), namely:

a main flow Fp that passes through the first row of obstacle separators 61 thereby performing a first separation of the oil that can flow primarily by gravity in the intermediate compartment 54 of the oil recovery chamber 5 via the communication means 71, then which passes through the second row of obstacle separators 62 thereby performing a second separation of the oil that can flow primarily by gravity in the main compartment 55 of the oil recovery chamber 5 via the communication means 72, then which passes through the third row of obstacle separators 63 thereby performing a third separation of the oil that can flow primarily by gravity in the main compartment 55 of the oil recovery chamber 5 via the communication means 73, and which lastly passes through the fourth capture means 64 to enter the outlet chamber 3;

a secondary flow Fs that passes through the first opening 52 to enter the intermediate compartment 54 of the oil recovery chamber 5, with which the flow entering via the communication means 71 is mixed, then which passes through the opening 56 to enter the main compartment 55 of the oil recovery chamber 5, with which the flows entering via the communication means 72 and 73 are mixed, and lastly which passes through the communication interface 53 to mix with the main flow Fp in the outlet chamber 3, the majority of the oil being evacuated outside the separator 1 via the separated oil return opening 50.

As illustrated in FIG. 10, in particular to prevent the oil from going from the third intermediate suction chamber 43 to the outlet chamber 3, the fourth capture means 64 can assume the form of a vertical drop, in particular of the step type, associated with a level difference or vertical drop between the respective bottoms of these two chambers 3 and 43. This vertical drop 64 thus forms an obstacle in the main flow Fp, in the same way as the preceding rows of obstacle separators 61, 62, 63, thereby allowing a last separation of the oil in the main flow Fp. The vertical drop 64 can assume the form of an inner rib in the casing 10 of the separator 1.

Likewise, in particular to prevent the oil from going from the main compartment 55 to the outlet chamber 3, the communication interface 53 assumes the form of a vertical drop, in particular of the step type, associated with a level difference between the respective bottoms of these two chambers 3 and 55. This vertical drop interface 53 also forms an obstacle in the secondary flow Fs thereby allowing a final separation of the oil in the secondary flow Fs. Moreover, this interface 53 is dimensioned to have a balance of the pressures between the main compartment 55 and the outlet chamber 3, independently of the gas circulation flow rate in the separator 1. Thus, the pressure in the main compartment 55 is substantially independent of the liquid phase oil inlets, in the form in particular of waves or jets or large drops. The vertical drop 53 can assume the form of an inner rib in the casing 10 of the separator 1.

In reference to FIGS. 10 and 11, the interface 53 assumes a substantially rectangular shape with a length Ll corresponding to its dimension in the longitudinal direction of the casing 10, and with a height Hl corresponding to its dimension in the vertical direction. As an example of adapted dimensioning of said interface 53 to balance the desired pressures, the length Ll is greater than or equal to 10 mm and the height Hl is greater than or equal to 10 mm. As an example of gas flow rates in the separator 1, the flow rate is generally between 0 and 5 liters per minute, and can even reach values in the vicinity of 200 liters per minute.

A second embodiment of the separator 1 according to the invention is illustrated in FIG. 12, which differs from the first embodiment in that the capture means 64 assume the form of a convergence area intended to concentrate the main flow Fp in the upper portion 13 of the separator 1, between the third intermediate suction chamber 43 and the outlet chamber 3. Instead of having a 90° step, here there is a sort of ramp or inclined wall 64, oriented towards the upper portion 13 of the separator 1 in the circulation direction of the main flow Fp. Thus, this inclined wall 64 accelerates the main flow Fp and causes it to converge opposite the separated oil return opening 50 forming the inlet of the siphon 51. Thus, the main flow Fp does not risk disrupting the storage and recovery area for the oil upstream of the siphon 51, while being oriented in the upper portion 13 of the separator 1.

This inclined wall 64, as illustrated in FIG. 13, forms a connecting wall between the bottom (or floor) of the outlet chamber 3 and the bottom of the third intermediate suction chamber 43; said bottoms of course not being situated at the same level in order to prevent the oil from going from the third intermediate suction chamber 43 to the outlet chamber 3.

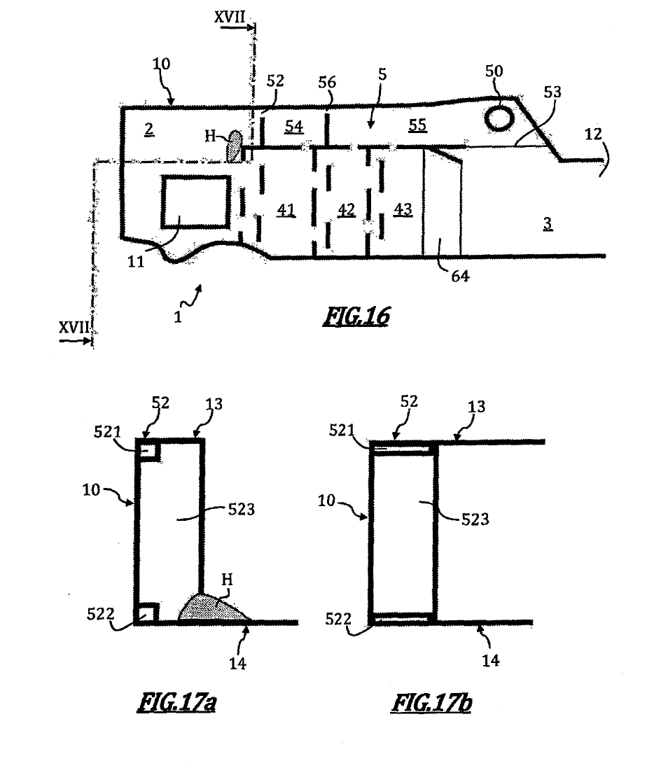

FIGS. 15a to 15c illustrate different embodiments of the communication means 52, 56, 71, 72 and 73. These communication means can comprise:

a circular opening, as illustrated in FIG. 15a, and/or

preferably a rectangular opening, as illustrated in FIG. 15b, in order to maximize the pressure drop in turbulent flow, and/or

also preferably an opening in the form of a plurality of square or rectangular holes, as illustrated in FIG. 15c, also in order to maximize the pressure drop in turbulent flow; the square or rectangular holes for example being aligned at the same level, i.e. all situated at the same height, and at regular intervals.

Of course, the shape of the openings is not limited to those described above, and the number and/or the dimensions of said openings must be determined as a function of the liquid-laden gas flows to be treated by the separator 1.

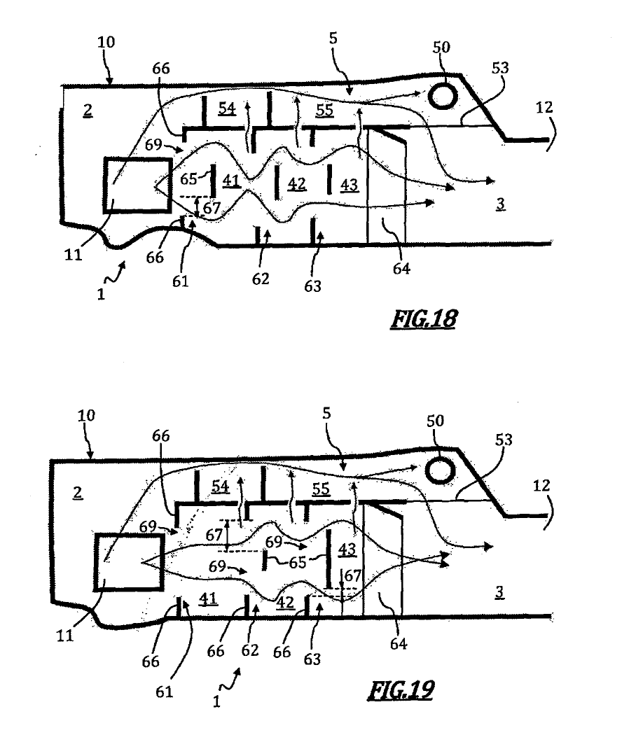

FIG. 16 illustrates the separator according to the second embodiment with a wave of oil H oriented towards the communication means 52 for putting the inlet chamber 2 and the intermediate compartment 54 of the oil recovery chamber 5 in communication. FIGS. 17a and 17b illustrate two embodiments of these communication means 52, which can of course be applied to the other communication means 56, 71, 72 and 73.

In FIG. 17a, the communication means 52 comprise two openings 521, 522 provided between the inlet chamber and the intermediate compartment of the oil recovery chamber, said openings 521, 522 being situated at distinct levels so that the opening 522 situated in the lower portion 14 of the separator 1, such as its floor, is dedicated primarily to the passage of the oil H and the opening 521 situated in the upper portion 13 of the separator 1 is dedicated primarily to the passage of the secondary flow Fs of gas. Of course, several openings can be provided at various heights or levels, said openings also being able to have the various shapes described above in reference to FIGS. 15a, 15b and 15c. In FIG. 17a, the openings 521, 522 are rectangular and are formed in the corners of the separating wall 523 between the inlet chamber 2 and the intermediate compartment 54.

In FIG. 17b, the two openings 521, 522 correspond to free spaces between the separating wall 523 and the upper 13 and lower 14 portions of the casing 10 of the separator, respectively. These free spaces 521, 522 are designed by fits and clearances of the separating wall 523, thereby facilitating the design and production of the separator 1. The separating wall(s) 523 can be assembled, in particular by clipping, with play in the casing 10 of the separator 1, so that the upper and lower plays, respectively, form openings 521 and 522, respectively.

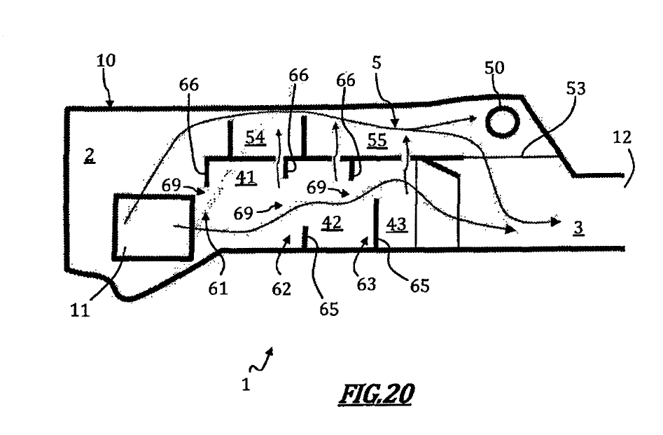

The separator 1 essentially being provided to evacuate the oil in liquid phase, it is possible to consider reducing the pressure drops caused by the first three successive capture means 61, 62 and 63, by modifying the geometry of said capture means 61, 62, 63 so that they have a reduced bypass effect of the main flow Fp, while of course keeping their abilities to recover the oil in liquid phase. The three embodiments illustrated in FIGS. 18, 19 and 20 constitute alternatives of the separator 1 according to the second embodiment illustrated in FIG. 12, where the only modifications concern the first three successive capture means 61, 62 and 63.

In the embodiment illustrated in FIG. 18, the capture means 61, 62, 63 comprise at least one obstacle separator as described above in reference to FIG. 14 where, for each separator 61, 62, 63, the bypass plate 65 has dimensions smaller than the passage opening 69 delimited by two coplanar walls 66, such that the interval 67 is large, for example having an area comparable to the area of the bypass plate 65. Such separators 61, 62, 63 create little pressure drop while still being as efficient in the separation of large drops or waves of oil.

In the embodiment illustrated in FIG. 19, the interval 67 decreases between the first separator 61 and the second separator 62, and also between the second separator 62 and the third separator 63. Thus, it should be noted that the first separator 61 does not comprise a bypass plate, such that the interval is maximal because it is completely combined with the passage opening 69. However, the second separator 62 comprises a bypass plate 65 opposite a passage opening 69 whereof the dimensions are such that they define an interval 67 with area S1. The third separator 63 also comprises a bypass plate 65 opposite a passage opening 69 whereof the dimensions are such that they define an interval 67 with area S2, where S2 is less than S1; the interval 67 being more significant for the second separator 62 than for the third separator 63. For example, for passage openings 69 with equal dimensions for the two separators 62, 63, correspond bypass plates 65 centered on said openings 69 where the bypass plate of the second separator 62 smaller than the bypass plate of the third separator 63.

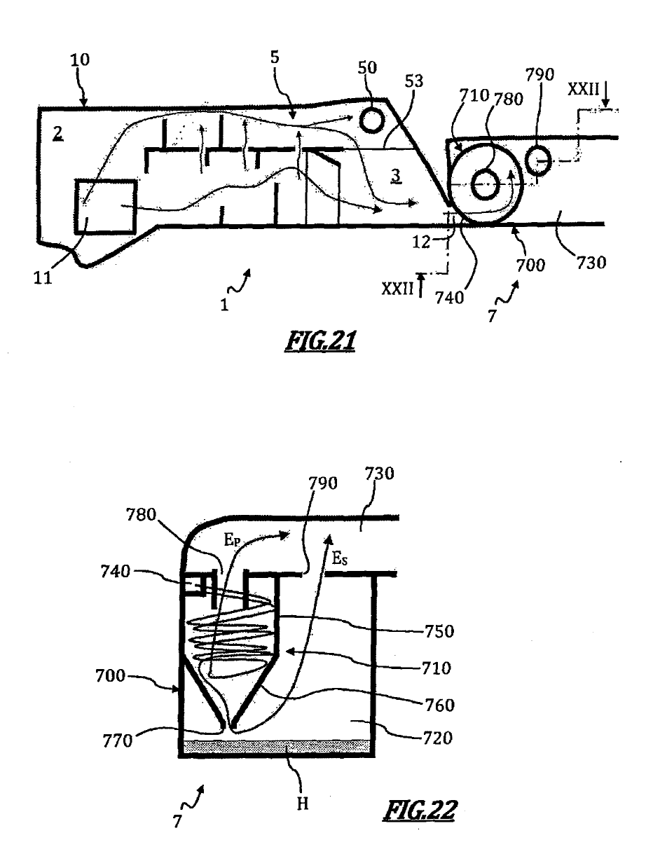

In the embodiment illustrated in FIG. 20, the principle is the same as that mentioned above with an interval 67 that decreases between the separators 61 to 63. In this embodiment, the difference is that the passage openings 69 are not delimited by two coplanar walls 66, but by a single wall 66 and by the casing 10 of the separator 1, in order in particular to reduce the overall dimensions of the separator 1 and to simplify its design and production, in particular the stripping step in case of production by molding of a plastic material. The associated bypass plate 65 constitutes a plate protruding from the casing 10, parallel to the wall 66 and offset in relation thereto in order to be situated opposite the corresponding passage opening 69; the bypass plate 65 of the second separator 62 being shorter than the bypass plate 65 of the third separator 63.

As already explained, the separator 1 according to the invention is essentially intended to separate oil entering in liquid phase, in particular in the form of waves or large drops. To treat the gases exiting this separator 1 and that may be laden with suspended oil particles, in other words in aerosol phase, it is provided to position, as illustrated in FIG. 21, a cyclone separator 7 behind said separator 1 to recover all or part of the remaining oil, in aerosol phase, in the gases exiting said separator 1.

As shown more precisely in FIG. 22, the cyclone separator 7 comprises a casing 700 delimiting an inner space containing:

a cyclone 710 designed to separate the oil, in the form of suspended particles, from the gases exiting the separator 1, via its outlet 12, according to the principle of separation by centrifugal effect;

a storage area 720 forming a storage volume for the oil H collected by the cyclone 710;

an outlet duct 730 to evacuate the cleaned gases outside the casing 700, said outlet duct 730 being in communication with the inlet line to return gasses in the cylinder head.

The cyclone 710 itself comprises, from top to bottom:

a tangential inlet 740 of the gases containing suspended drops of oil to be eliminated, said tangential inlet 740 being positioned in the upper portion of said cyclone 710 in the direct extension of the outlet 12 of the separator 1;

a capture area 750 formed by a cylindrical wall, where the drops of oil are projected on said cylindrical wall;

an oil recovery area 760 formed by a conical wall in the extension of the capture area 750 and ending in its lower portion of smaller diameter with a lower central opening 770.

The cyclone 710 also comprises an upper central opening 780 through which part of the flow of cleaned gases emerges axially from the capture 750 and storage 720 areas to go into the outlet duct 730.

The lower central opening 770 emerges in the storage area 720 to allow an evacuation of the oil by gravity from the cyclone 710 towards the storage area 720. The outlet duct 730, advantageously horizontal, plays the role of a suction pipe for the cleaned gases, starting from the upper central opening 740 to the outside of the casing 700 of the cyclone separator 7.

A communication is done between the upper portion of the storage area 720 on one hand, and a point of the outlet duct 730 on the other, through a suction opening 790 formed in the wall separating them.

During operation, the gases admitted in the cyclone 710 through the tangential opening 740 are divided into:

a main flow Ep first descending in a spiral, then rising and axially exiting via the upper central opening 780 to rejoin the outlet duct 730; and

a secondary flow Es escaping through the lower central opening 770, then passing through the storage area 720 and passing through the suction opening 790 to finally rejoin the outlet pipe 730 and join the main flow Ep.

The storage volume provided in the storage area 720 is dimensioned to store oil throughout the entire operating direction of the combustion engine, the oil thus stored then being evacuated in the engine when said engine is stopped. For example, such a dimensioning can be provided to allow storage for 4 hours of the oil arriving in the form of small drops in aerosol phase for a worn engine operating at full power. As a reminder, a worn motor operating at full power produces a flow rate of oil in small drop form in the vicinity of 4 g/h, while the flow rate of oil arriving in the form of large drops, jets or waves is in the vicinity of 1200 g/h. Thus, the storage area 720 of the cyclone separator 7 can be dimensioned to collect about 16 g of oil, or even more as a precaution.

A check valve, not illustrated, can be provided in the bottom of the storage area 720, which only opens when the pressures are identical on each side of the check valve, i.e. when the internal combustion engine is stopped, thereby allowing the return of the stored oil towards the engine.

Of course, other types of cyclone separators can be considered, like those described in French patent application FR 2922126, both in the preamble of that patent application and in its specific description.

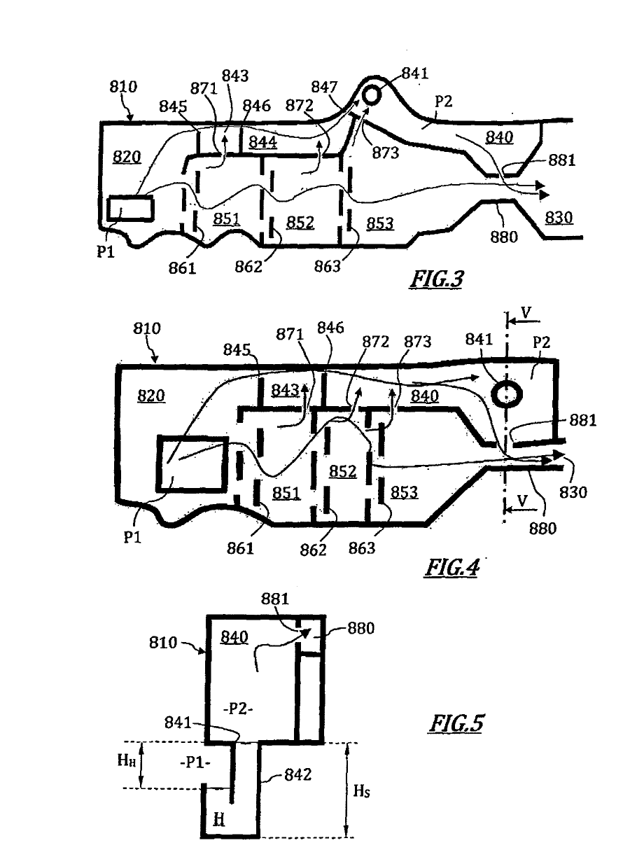

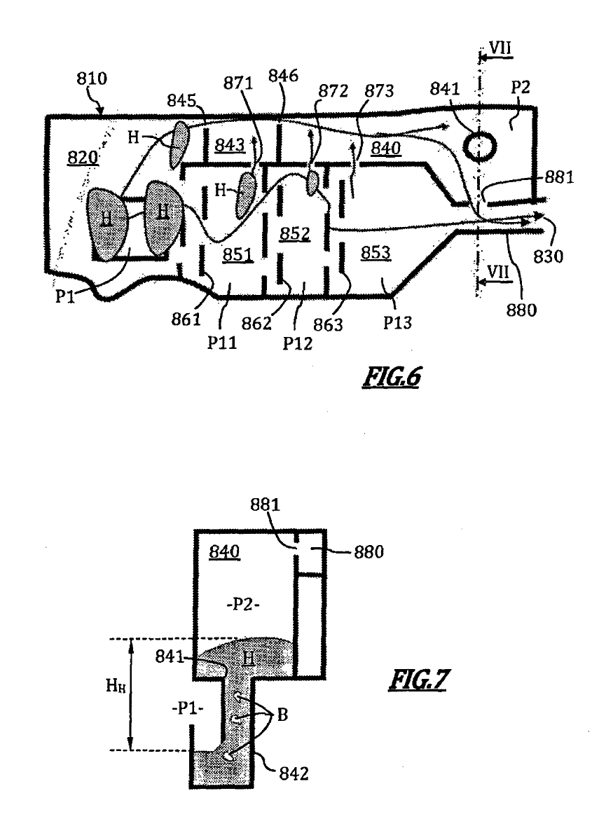

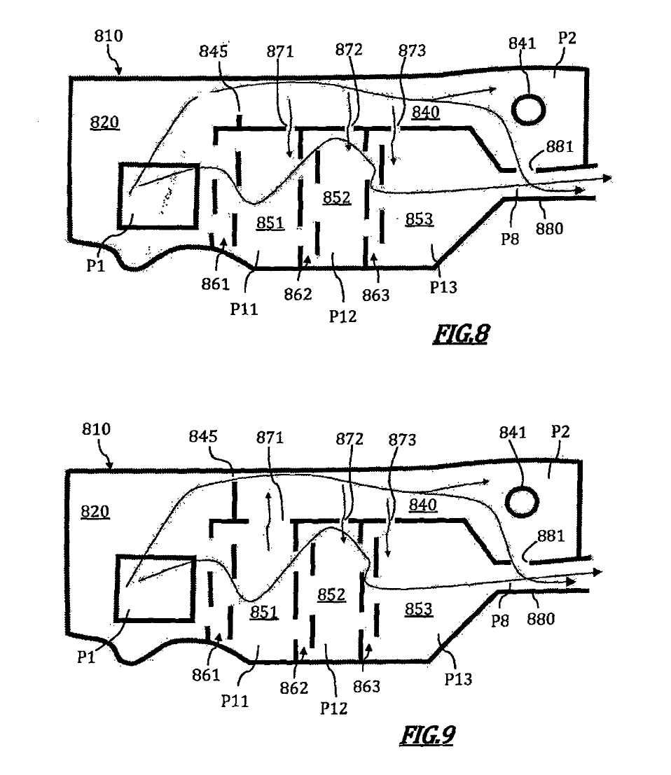

Moreover, such a combination of a cyclone separator with a separator can be considered with a separator of the prior art equipped with a venturi, like those illustrated in FIGS. 3, 4, 8 and 9.

Of course, the embodiments cited above are in no way limiting and other details and improvements can be made to the separator according to the invention, without going beyond the scope of the appended claims, providing in particular other numbers, shapes, and arrangements of the intermediate suction chambers and/or compartments of the oil recovery chamber, for example by superimposing these chambers or compartments, and/or providing other forms of communication between the different chambers and/or compartments, and/or by providing other shapes, numbers, arrangements, dimensioning of the oil capture means.

1. An oil separator for an internal combustion engine, for at least partially separating the oil from the gases exiting a crankcase of an internal combustion engine, the separator comprising a casing containing therein:
an inlet chamber for the oil-laden gases;
an outlet chamber for the cleaned gases;
at least one intermediate suction chamber situated between the inlet chamber and the outlet chamber of the gases and delimited by oil capture means positioned on the circulation path between the inlet chamber and the outlet chamber of the gases, and
an oil recovery chamber with an opening for returning the separated oil to the engine, said opening being situated in the lower portion of the separator, said oil recovery chamber being adjacent to the intermediate suction chamber(s), said or each intermediate suction chamber being in communication with said oil recovery chamber via communication means (71, 72, 73), and said oil recovery chamber being in communication on one hand with the gas intake chamber via communication means, and on the other hand with the outlet chamber via a communication interface between the two said chambers,
wherein the communication interface between the oil recovery chamber and the gas outlet chamber is dimensioned so that the pressures in each of said chambers are substantially equal during use of the separator independently of the circulating flow rate of the gases inside said separator.

2. The separator according to claim 1, wherein the communication interface between the oil recovery chamber and the gas outlet chamber assumes the form of a vertical drop, in particular of the step type, associated with a level difference between the respective bottoms of said chambers in order to prevent the oil accumulating in the oil recovery chamber from passing into the gas outlet chamber via said communication interface.

3. The separator according to claim 1, wherein the oil recovery chamber includes several successive compartments, in communication via communication means, including:
a main compartment in which the separated oil return opening is provided, and
at least one intermediate compartment situated between the gas intake chamber and the main compartment,
each compartment being adjacent to at least one suction chamber with which it is in communication via communication means (71, 72, 73).

4. The separator according to claim 1, wherein the sole intermediate suction chamber or the intermediate suction chamber directly upstream of the outlet chamber is in communication with said outlet chamber via a convergence area intended to concentrate the gas circulation flow in the upper portion of the separator, opposite the lower portion of the separator in which the separated oil return opening is situated.

5. The separator according to claim 4, wherein the convergence area assumes the form of a wall inclined on the horizontal, oriented towards the upper portion of the separator in the circulation direction of the gas flow, in particular forming a connecting wall between the bottom of the outlet chamber and the bottom of said intermediate suction chamber when said bottoms are not situated at the same level.

6. The separator according to claim 1, wherein all or part of the communication means comprise at least one opening provided between the two corresponding communicating compartments or chambers.

7. The separator according to claim 6, wherein all or part of the communication means comprise at least two openings provided between the two corresponding communicating compartments or chambers, said openings being situated at distinct levels so that an opening situated in the lower portion of the separator is dedicated primarily to the passage of the oil and an opening situated in the upper portion of the separator is dedicated primarily to the passage of the gases.

8. The separator according to claim 7, wherein the two openings correspond to free spaces between a separating wall of the two corresponding compartments or chambers and the casing of the separator, said separating wall being mounted with play inside said casing, in particular through an assembly by clipping.

9. The separator according to claim 6, wherein said or each opening is oblong, in particular rectangular, or square.

10. The separator according to claim 6, wherein said or each openings assumes the form of a plurality of holes, in particular polygonal holes, preferably rectangular or square.

11. The separator according to claim 1, wherein all or part of the oil capture means comprise an obstacle separator, said obstacle separator comprising at least one passage opening of the gases associated with bypass means positioned opposite said passage opening in order to deviate all or part of the gases passing through said passage opening.

12. The separator according to claim 11, comprising several successive intermediate suction chambers separated from each other by oil capture means each comprising an obstacle separator, or two successive obstacle separators, a first separator and a second separator, respectively, placed downstream of the first separator, are designed so that the first separator deviates less gas flow than the second separator.

13. The separator according to claim 12, wherein the oil capture means provided between the gas inlet chamber and the intermediate suction chamber directly downstream comprise at least one gas passage opening.

14. An oil separator device for an internal combustion engine, for at least partially separating the oil from the gases exiting a crankcase of an internal combustion engine, comprising a separator according to one of claim 1 and a cyclone separator placed downstream of said separator to recover all or part of the oil remaining in the gases exiting said separator.
